(19) United States
(12) Patent Application Publication
(10) Pub. No.: US 2022/0087236 A1
(43) Pub. Date: Mar. 24, 2022

(54) CARBON FIBER REINFORCED POLYMER COMPOSITES BASED FISHING HOOK

(71) Applicant: Advanced Angling Materials, Inc., Tiverton, RI (US)

(72) Inventors: Miles C. Wilson, Tiverton, RI (US); James M. Wilson, Newcastle, ME (US)

(21) Appl. No.: 17/479,949

(22) Filed: Sep. 20, 2021

Related U.S. Application Data
(60) Provisional application No. 63/080,230, filed on Sep. 18, 2020.
(60) Provisional application No. 63/168,749, filed on Mar. 31, 2021.

(51) Int. Cl. A01K 83/00

(52) U.S. Cl. CPC A01K 83/00

(57) ABSTRACT

A fishing hook composition includes carbon fiber, graphene fiber, or natural fibers reinforced polymer composite, wherein the carbon fiber, the graphene fiber, or the natural fibers are embedded in the reinforced polymer composite with or without coupling agents.

### CROSS REFERENCE TO RELATED APPLICATIONS

This application claims benefit from U.S. Provisional Patent Application Ser. No. 63/080,230, filed Sep. 18, 2020, and U.S. Provisional Patent Application Ser. No. 63/168,749, filed Mar. 31, 2021, which each are incorporated by reference in their entireties.

### BACKGROUND OF THE INVENTION

This invention generally relates to outdoor sports, and more specifically to a carbon fiber reinforced polymer composites based fishing hook.

In general, a fishing hook is a tool used for catching fish by impaling a fish in the mouth. fishing hooks have been employed by anglers to catch fresh and saltwater fish. fishing hooks are generally attached to some form of a line or through an eyelet which is located at one end of a fishing hook. A significant variety of fishing hooks are used to catch fish. fishing hooks vary in size, designs, shapes and materials. fishing hooks are designed to hold various types of artificial, processed, dead or live baits (i.e., bait fishing), to act as the foundation for artificial representations of fish prey (i.e., fly fishing), or to be attached to or integrated into other devices that represent fish prey (i.e., lure fishing).

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a fishing hook composition including carbon fiber, graphene fiber, or natural fibers reinforced polymer composite, wherein the carbon fiber, the graphene fiber, or the natural fibers are embedded in the reinforced polymer composite with or without coupling agents.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is an illustration of an exemplary fishing hook.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

The term “corrosion resistant material” as used herein is intended to represent material which does not corrode or oxidize easily when exposed to water, salt water, moisture, and the like.

The term “carbon fiber reinforced polymer” as used herein represents a combination of a polymer matrix infused/embedded with carbon fibers.

The term “carbon fiber” as used herein is intended to represent carbon based fibrous materials such as graphene fibers, which possess high flexibility, superior toughness, good conductivity, high thermal conductivity and low density.

The term “coupling agents” as used herein represents compounds which facilitates a chemical bonding between two dissimilar materials, usually an inorganic and an organic material. This term can also represent a chemical agent which improves the adhesion between two phases in a composite material.

The term ‘composite’ is used here to denote a material which has two or more distinct constituents, not chemically bound to each other.

The term “polymer matrix” represents a polymer matrix composite (PMC) and is a composite material composed of a variety of short or continuous fibers bound together by an organic polymer matrix.

As used herein, a high stiff engineering thermoplastic is a material which possesses better mechanical properties like rigidity and or thermal properties such as heat resistance as reflected by higher heat distortion temperatures than the more widely used commodity plastics such as polyethylene, PVC or Polystyrene, and so forth.

The term “ionomer” as used herein represents chemical entities of a class of impact resistant synthetic ethylene-based thermoplastic resins consisting of a copolymer of ethylene with acid containing comonomers wherein some or all of the acid groups are neutralized by suitable cations to provide ionic cross-links.

The term “thermoplastic polyurethanes” as used herein represents chemical entities of a class of impact resistant materials based on the aromatic or aliphatic diisocyanate with aliphatic or aromatic diols or polyols.

The term “thermoset polyureas” as used herein represents chemical entities of a class of impact resistant materials based on the aromatic or aliphatic diisocyanate with aliphatic or aromatic diols or polyols and diamines. It also includes aromatic or aliphatic isocyanates with aliphatic or aromatic diamines.

The term “thermoset polyurethanes” as used herein represents chemical entities of a class of impact resistant materials based on the aromatic or aliphatic diisocyanate with aliphatic or aromatic diols or polyols which are further crosslinked chemically by disocynate or by radiation techniques.

The term “graphene” as used herein represents a thick sheet of carbon atoms arranged in a honeycomb-like pattern. Graphene is considered as the world's strongest material, and can be used to enhance the strength of other materials.

Many previous fishing hook 10s are made using metals such as iron. While metals are strong and sturdy, they tend to corrode when exposed to significant moisture, especially to sea salt water, as well as being stored in containers with high degree of moisture.

Several attempts have been made in the past to prevent corrosion of iron by anodizing the metals or using steel which is an alloy of iron and carbon, containing less than 2% carbon and 1% manganese or stainless steel alloys which is an alloy of iron with chromium, manganese, silicon, carbon and, in many cases, with significant amounts of nickel and molybdenum. However, both steel and stainless steel or other metal alloys have inferior tensile or flexural modulus properties and the hooks made out of them are prone to oxidation which results in a subsequent decrease in the modulus of rupture and overall strength of the hook. There is thus a need for fishing hook 10s that are resistant to corrosion, oxidation, or other forms of decay.

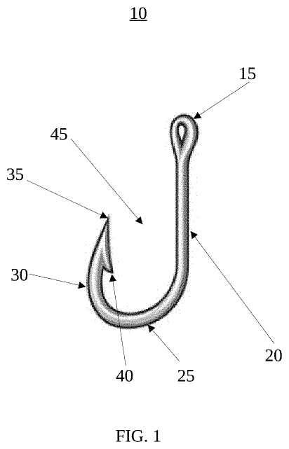

In FIG. 1, an exemplary fishing hook 10 (also referred to as “tackle”) 10 includes an eye 15, a shank 20, a bend 25, a throat 30, a point 35, a barb 40 and a gap 45. While fishing hook 10 is one example, embodiments of the invention may be used with tackle of all shapes and sizes, such as, for example, a treble hook, a dual hook, a swivel, a circle hook, a ball bearing swivel, a barrel swivel, a quick swivel, a bait hook, as so forth.

In an embodiment, the fishing hook 10 is made from a composition including carbon fiber, graphene fiber, or natural fibers reinforced polymer composites, wherein the carbon fiber, graphene fiber, or natural fibers are embedded in the polymer matrix material with or without coupling agents.

In another embodiment, the fishing hook 10 is made from a composition including graphene fiber reinforced polymer composites, wherein the graphene fiber is embedded in the polymer matrix material with or without coupling agents.

In another embodiment, the fishing hook 10 is made from a composition including natural fibers reinforced polymer composites wherein the graphene fiber is embedded in the polymer matrix material with or without coupling agents.

In embodiments, the polymer matrix material is selected from a group consisting of thermosets and thermoplastics. In a preferred embodiment, the thermoset polymer matrix material is selected from a group consisting of crosslinked polyurethanes, crosslinked polyureas, epoxy resins, crosslinked polyacrylonitrile, crosslinked silicones, crosslinked polyacrylics.

In embodiments, the thermoplastics polymer matrix material is reinforced with continuous or non-continuous carbon fibers, whereby the carbon fiber reinforced polymer yields higher tensile properties compared to the polymer material alone.

In embodiments, the thermoplastics polymer matrix material is selected from a group consisting of ultra-high molecular weight and high-density polyethylene, ionomers, and high stiffness engineering thermoplastics.

In embodiments, the high stiff engineering thermoplastics polymer matrix material is selected from a group consisting of polysulfones, polyimides, polyetherketones (PEEK), poly (phenylene oxide) (Noryl, PPO), polybutylene terephthalate (PBT), polyimidazoles, polyamides-imides, thermoplastic polyurethanes, acrylonitrile-butadiene-styrene (ABS), Nylon 6, Nylon 66, Nylon 611, Nylon 612 and engineering thermoplastic blends.

In embodiments, the engineering thermoplastic blends are selected from a group consisting and blends of PBT blends of PBT/ABS, PBT/Polysulfones, PBT/polyimides, PBT/PEEK, PBT/PPO, PBT/Nylon 6 or 66, 611, 612, blends of PBT or PEEK or PPO or Nylon 6 or Nylon 66 or Nylon 611 or Nylon 612 with ethylene-propylene rubber (EPR) or ethylene-propylene-diene rubber (EPDM) or ionomers.

Yet another aspect of the present invention provides an embodiment wherein the ionomers of the thermoplastics polymer matrix material are selected from a group consisting of ethylene-acrylic or methacrylic acid copolymers neutralized with metal cations or ethylene-acrylic or methacrylic acid-alkyl acrylate copolymers neutralized with metal cations. A further preferred embodiment of this aspect provides a fishing hook 10 wherein the metal cation is selected from a group consisting of Li, Na, Zn, Mg or Ca metal ions.

Provided in another embodiment of the present invention is a fishing hook 10 wherein the carbon fiber or the graphene fiber ratio of a filament material's Young's modulus to a matrix material's Young's modulus is between about 5 and about 10,000. Young's modulus, a numerical constant, describes the elastic properties of a solid undergoing tension or compression in only one direction. Young's modulus is a measure of the ability of a material to withstand changes in length when under lengthwise tension or compression. A preferred embodiment of this aspect provides a fishing hook 10 wherein the carbon fiber or graphene fiber-based polymer composites material has a tensile modulus of between about 10,000 psi and about 5,000,000 psi. The carbon fiber or the graphene fiber has a tensile modulus from 10,000,000 to 80,000,000 psi.

Yet another preferred embodiment of this aspect of the invention provides a fishing hook 10 wherein the carbon fiber or graphene fiber-based polymer composites material has a heat distortion temperature in the range of 50 to 300° C., and has a surface area ranging from 5 m²/g to 400 m²/g. A further preferred embodiment provides a fishing hook 10 wherein the carbon fiber or graphene fiber has a surface area ranging from 400 m²/g to 800 m²/g.

The foregoing description of the preferred embodiments of the invention is by way of example only, and other variations of the above-described embodiments and methods are provided by the present invention. The embodiments described herein have been presented for purposes of illustration and are not intended to be exhaustive or limiting. Many variations and modifications are possible in light of the foregoing teaching. The invention is limited only by the following claims.

What is claimed is:

1. A fishing hook composition comprising:
carbon fiber, graphene fiber, or natural fibers reinforced polymer composite,
wherein the carbon fiber, the graphene fiber, or the natural fibers are embedded in the reinforced polymer composite with or without coupling agents.

2. The fishing hook composition of claim 1 wherein the polymer composite is selected from a group consisting of thermosets and thermoplastics.

3. The fishing hook composition of claim 2 wherein the thermosets are selected from a group consisting of crosslinked polyurethanes, crosslinked polyureas, epoxy resins, crosslinked polyacrylonitrile, crosslinked silicones, crosslinked polyacrylics.

4. The fishing hook composition of claim 2 wherein the thermoplastics are reinforced with continuous or non-continuous carbon fibers to yield high tensile properties.

5. The fishing hook composition of claim 4 wherein the thermoplastics are selected from a group consisting of ultra-high molecular weight and high-density polyethylene, ionomers, and high stiffness engineering thermoplastics.

6. The fishing hook composition of claim 5 wherein the high stiffness engineering thermoplastics are selected from a group consisting of polysulfones, polyimides, polyetherketones (PEEK), poly (phenylene oxide) (Noryl, PPO), polybutylene terephthalate (PBT), polyimidazoles, polyamides-imides, thermoplastic polyurethanes, acrylonitrile-butadiene-styrene (ABS), Nylon 6, Nylon 66, Nylon 611, Nylon 612 and engineering thermoplastic blends.

7. The fishing hook composition of claim 6 wherein the engineering thermoplastic blends are selected from a group consisting and blends of PBT blends of PBT/ABS, PBT/Polysulfones, PBT/polyimides, PBT/PEEK, PBT/PPO, PBT/Nylon 6 or 66, 611, 612, blends of PBT or PEEK or PPO or Nylon 6 or Nylon 66 or Nylon 611 or Nylon 612 with ethylene-propylene rubber (EPR) or ethylene-propylene-diene rubber (EPDM) or ionomers.

8. The fishing hook of claim 7 wherein the ionomers are selected from a group consisting of ethylene-acrylic or methacrylic acid copolymers neutralized with metal cations or ethylene-acrylic or methacrylic acid-alkyl acrylate copolymers neutralized with metal cations.

9. The fishing hook of claim 8 wherein the metal cations are selected from a group consisting of Li, Na, Zn, Mg or Ca metal ions.

10. The fishing hook composition of claim 1 wherein a carbon fiber or the graphene fiber ratio of a filament material's Young's modulus to a polymer composite material's Young's modulus is between 5 and 10,000.

11. The fishing hook composition of claim 1 wherein the carbon fiber or graphene reinforced polymer composite has a heat distortion temperature in the range of 50 to 300° C., and a surface area from 5 m²/g to 400 m²/g.

12. The fishing hook composition of claim 1 wherein the carbon fiber or graphene fiber has a surface area from 400 m²/g to 800 m²/g.
